(19) United States
(12) Patent Application Publication
(10) Pub. No.: US 2002/0190006 A1
(43) Pub. Date: Dec. 19, 2002

(54) Substance precipitation

(76) Inventor: Gunter Hofmann, Duisburg (DE)

Correspondence Address: CANTOR COLBURN, LLP, 55 GRIFFIN ROAD SOUTH, BLOOMFIELD, CT, 06002

(21) Appl. No.: 10/172,635

(22) Filed: Jun. 14, 2002

(30) Foreign Application Priority Data
Jun. 15, 2001 (DE) 101 28 663.5
Aug. 18, 2001 (DE) 101 40 648.7

(51) Int. Cl. C02F 1/52

(52) U.S. Cl. 210/723

(57) ABSTRACT

The invention presented herein concerns a method for precipitation of substances dissolved or suspended in a homogenous organic phase, whereby the organic phase forming a miscibility gap with water is continuously driven off by water vapor distillation and the substances not soluble in water are at the same time preserved, whereby the homogenous organic phase is vaporized in at least two stages using indirect heating and a water additive corresponding to the miscibility gap of the respective stage, whereby the stages are fed parallel in order to emulsify the solids or viscous concentrates in the water.

The present invention concerns a process for precipitation of substances dissolved or suspended in a homogeneous organic phase, whereby the organic phase, forming a miscibility gap with water, is continuously driven off by water vapor distillation, and the substances not soluble in water are preserved.

On the basis of a homogeneous organic phase, which contains dissolved or suspended substance or substances, for example polymer substances, these should be extracted in that the organic phase forming a miscibility gap with water is continuously driven off as far as possible with water distillation, and the substances which are not soluble in water, for example polymer substances, are thereby preserved, for example as solids or as viscous concentrates. These precipitated solids or viscous concentrates may still contain only a few ppm (parts per million) of the organic solvent after precipitation.

With water vapor distillation by known the state of the art technology, the presence of the second, not miscible liquid phase is used in order to vaporize this second phase in an energy-saving manner. The physical principle of water vaporization is known and most thoroughly described in numerous textbooks.

The so-called stripping according to the principle of water vapor distillation requires the direct introduction of water vapor for expelling the organic phase. The liquor mixtures arising can no longer be effectively used for a further stage for stripping the organic phase in the same manner, since these already contain expelled organic phase. Multiple stage facilities according to the principle of direct water vapor distillation are therefore especially energy-intensive.

Above and beyond this, the arising of solids or viscous concentrates require the use of vaporizer designs suitable for solids, for example the use of forced circulation vaporization or the like. Rectification columns, therefore, do not come into consideration as vaporizers operating in multiple stages for this application for substance precipitation.

Underlying the invention, in view of this state of the art of technology, is the objective of readying a method of the type named at the beginning, which makes possible a substance precipitation using water vapor distillation in an energy-saving manner and, thereby, especially reduces the residual content in organic solvent in the solids arising to the least content possible.

The objective is solved in accordance with the invention, in that the homogenous organic phase is vaporized in at least two stages using indirect heating and a water additive, corresponding to the miscibility gap of the respective stage, whereby the stages are fed parallel in order to emulsify the solids or viscous concentrates arising in the water. Advantageously, the solids or viscous concentrates arising are emulsified in the water into a suspension, which is subsequently ground in a wet state.

In accordance with the invention, the suspension emerging from vaporization is reprocessed since the suspension is ground in a wet state, preferably without significant heat development. Through wet grinding, the remaining solvent amounts still under capillary process included in the particles of the solids are released. Temperature-dependent decomposition processes are thereby avoided by grinding in wet state. The solvent released by the wet grinding is dissolved in the carrier water. In a separation facility connected downstream in series, further depleted solids are separated from the henceforth solvent-containing carrier water lot.

Advantageously, the suspension is ground down in a wet mill to a particle size, optimized for depleting the residual solvent. In accordance with another advantageous configuration of the invention, an additional batch vaporization is interposed between the grinding and a mechanical separation devices for separating the solvent-containing carrier water amount for stripping the solvent in order to reduce the solvent contents which remain in the residual moisture following separation in the wet residue even further.

Advantageously, the water components of the condensates, separating again, are used as a water additive at each stage.

Through the complete avoidance of direct steam introduction, existing in accordance with the invention, an energy-saving substance separation is administered through multiple stage water vapor distillation. Through the multiple stage vaporization, with indirect heating and (since the otherwise directly introduced water component is lacking) corresponding water addition at each stage, as well as the parallel feeding in order to level off the viscosity of the concentrates arising by emulsifying these in the carrier medium water, the high energy expenditure that previously was present within the framework of substance precipitation with water vapor distillation is reduced.

The indirect water vapor distillation existing in accordance with the invention is especially advantageous where the liquor composition is rich in organic phase.

Additional details, features and advantages of the invention will be explained below on the basis of the design examples shown in the figures, wherein:

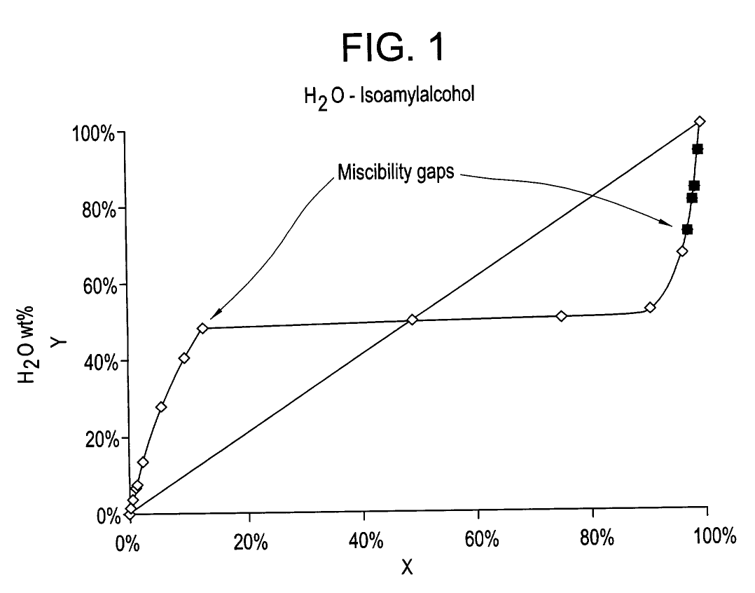

FIG. 1 Depicts a phase system of water vapor distillation of iso-amyl alcohol and

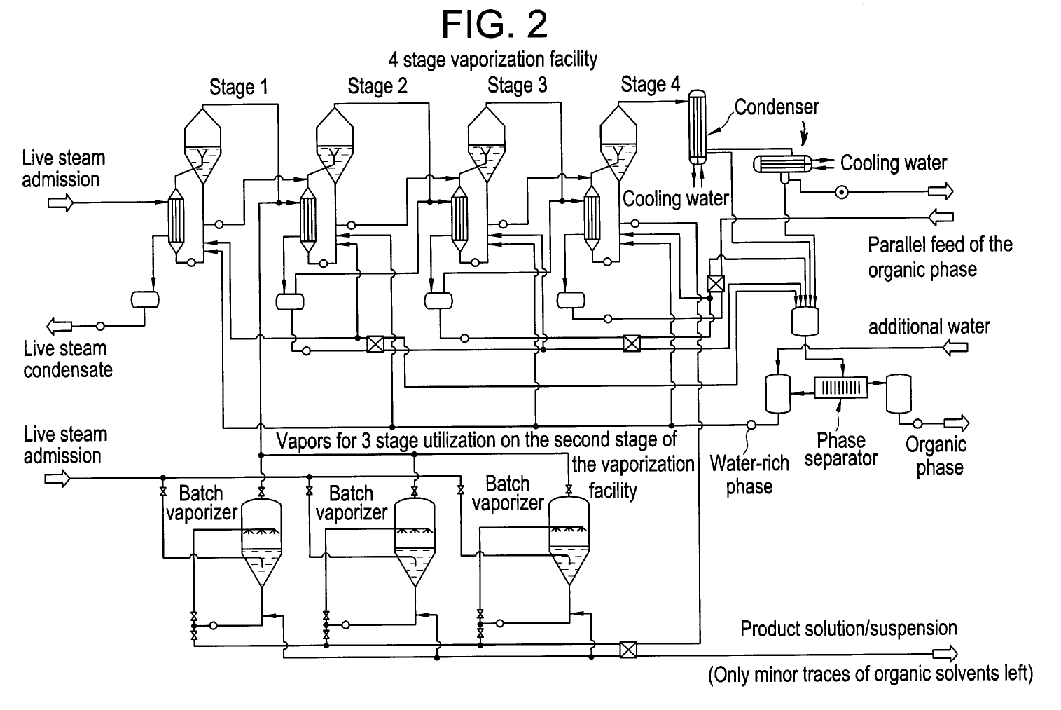

FIG. 2 Illustrates, in a block diagram, the principal structure of a multiple stage vaporization facility for conducting the process of the invention

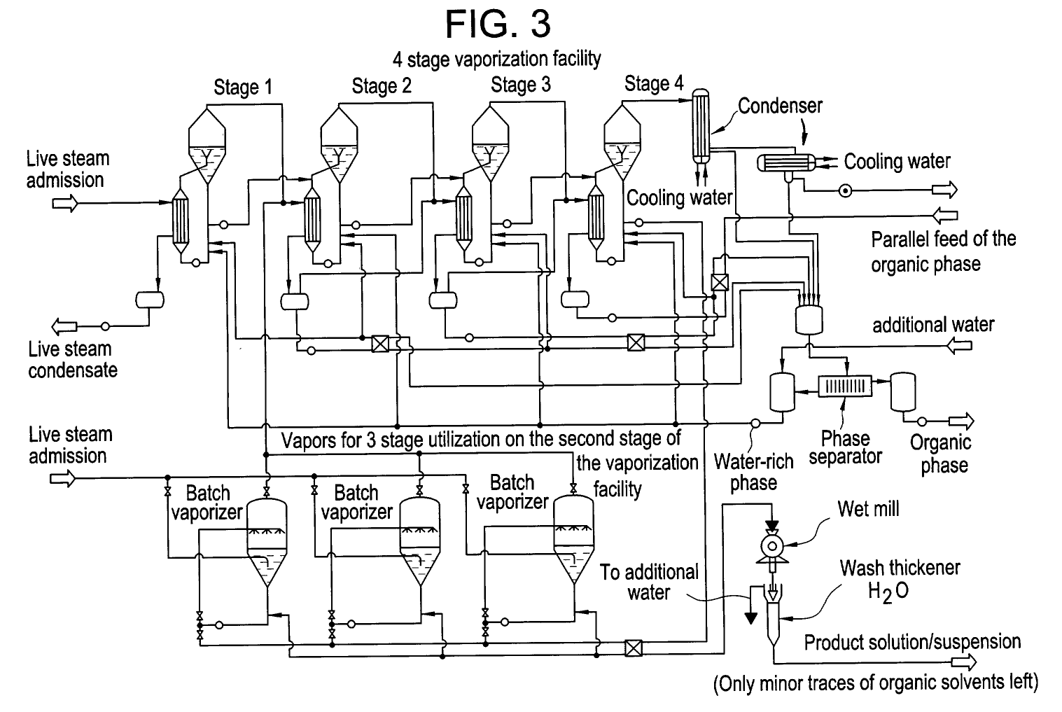

FIG. 3 Shows in a block diagram the principle structure of a further multiple stage vaporization facility for conducting the process of the invention with wet state grinding.

On the basis of the phase system in accordance with FIG. 1, it can be recognized that with a water component between about 15% and 90%, the liquor composition is rich in organic phase so that the vaporizer, connected in at least two stages, can be operated near a water component of 90%. With higher yield of the organic phase of the example represented in FIG. 1, the content in organic components in the liquor drops. After the miscibility gap disappears, then the energy-advantageous principle of water vapor distillation also departs, as is to be recognized on the basis of FIG. 1.

The concentrates from the multiple state vaporization are therefore reprocessed to drive out the remaining components in organic solvent. On account of the precipitation of ingredients as solids or viscous concentrates, a step-wise or intermittent reprocessing is also advantageous, which is more effective energy-wise than a reprocessing in a continuously operated cascade, and drives out the remaining, dissolved component in organic phase up to the desired traces. Advantageously, this stage is operated at such a temperature that the liquors of this stage can be fed into the preceding multiple stage vaporization facility in an energy-saving manner.

FIG. 2 shows the principal structure of a vaporization facility for precipitation using indirect water vaporization. In the upper region of FIG. 2, a vaporization facility constructed in the present case in four stages is represented. The lower region of FIG. 2 depicts the so-called batch vaporization for expelling the remaining contents. This is constructed here in three stages, whereby at any given time one of the three stages is in operation, one is empty, and one is being filled. The liquors are presently in the second stage of the continuous multiple stage vaporization in order to be able to use the highest temperatures possible. Advantageously, the delivery of the liquors takes place at the highest temperature possible in the framework of batch vaporization in stages.

The suspension, thus obtained, is subsequently fed in connection with a vaporization facility for substance precipitation in accordance with FIG. 3 for further depletion of solvents to a wet mill, which is connected in series upstream from a water-operated wash thickener as a separation device. With the wash thickener, the solids further depleted from solvent in the wet mill are separated from the henceforth solvent-containing carrier water. The solids are here separated in the form of a solution or suspension on the basis of certain residual moisture.

The design examples represented in the figures serve merely to explain the invention and are not restrictive with respect to it.

1. Process for precipitation of substances suspended or dissolved in a homogenous organic phase from the homogenous organic phase, whereby the organic phase forming a miscibility gap with water is continuously driven off as much as possible by water distillation and the substances not soluble in water are preserved at the same time, is characterized in that the homogenous organic phase is vaporized at at least two stages using indirect heating and a water additive corresponding to the miscibility gap of the respective stage, whereby the stages are fed in parallel to emulsify the solids or viscous concentrates arising in water.

2. Process according to claim 1, is characterized in that the solids or viscous concentrates arising in the water are emulsified to a suspension which is subsequently ground in wet state.

3. Process according to claim 1 or 2, is characterized in that the water component of the separated again condensates are used as a water additive at each stage.

4. Process according to one of claims 1 to 2, is characterized in that the substances are emulsified by parallel feeding into water.

5. Process according to claims 1 to 4, is characterized in that the batch vaporization is conducted in three stages to drive off the remaining contents, whereby at any given time, one stage of the three stages is in operation, one is empty, and one is being filled.

6. Process according to claim 5, is characterized in that the liquors of the batch vaporization are at a stage of the highest possible temperature of continuous multiple stage vaporization.

7. Process according to one of claims 1 to 6, is characterized in that the grinding to a particle size optimized for depleting solvents is adjustable.

8. Process according to one of claims 1 to 7, is characterized in that the solids are separated from the suspension following grinding.

9. Process according to claim 8, is characterized in that an additional batch vaporization is interposed between grinding and separation.
